(19) United States
(12) Patent Application Publication
(10) Pub. No.: US 2023/0140262 A1
(43) Pub. Date: May 4, 2023

(54) ANTI-LOOSENING FASTENER FOR FUEL CELL STACKS

(71) Applicant: JIS Co., Ltd., Daejeon (KR)

(72) Inventor: In Ho KIM, Daejeon (KR)

(21) Appl. No.: 17/536,640

(22) Filed: Nov. 29, 2021

(30) Foreign Application Priority Data
Nov. 2, 2021 (KR) 10-2021-0148607

(51) Int. Cl. F16B 37/08; F16B 33/00; F16B 39/12; F16B 39/282

(52) U.S. Cl. CPC F16B 37/085; F16B 33/002; F16B 39/126; F16B 39/282

(57) ABSTRACT

Disclosed herein is an anti-loosening fastener for fuel cell stacks, which is capable of maintaining performance of a fuel cell stack and prolonging a life of a fuel cell by preventing the fastener for coupling unit cells of the fuel cell stack from loosening due to vibration generated during driving.

### CROSS-REFERENCE TO RELATED APPLICATION

The present application claims priority under 35 U.S.C. § 119(a) to Korean patent application number 10-2021-0148607 filed on Nov. 2, 2021, the entire disclosure of which is incorporated by reference herein.

### BACKGROUND

### 1. Technical Field

The present disclosure relates to an anti-loosening fastener for fuel cell stacks, and more particularly, to an anti-loosening fastener for fuel cell stacks, which is capable of maintaining performance of a fuel cell stack and prolonging a life of a fuel cell by preventing the fastener for coupling unit cells of the fuel cell stack from loosening due to vibration generated during driving.

### 2. Related Art

In general, a fuel cell stack is formed by stacking a plurality of unit cells. In the fuel cell stack, the cathode of one unit cell is electrically connected to the anode of an adjacent unit cell, and the unit cells are fastened to each other at the same pressure as a whole when they are stacked in order to prevent leakage, bending, and the like.

The fuel cell stack includes a separator, a gasket, a gas diffusion layer, a membrane electrode assembly (MEA), a compression plate, a current collector, etc., and these components are included in each unit cell. The fuel cell stack is manufactured by stacking unit cells according to the desired output and finally fastening them using full threaded bolts.

In a fuel cell stack manufactured by fastening unit cells using a plurality of full threaded bolts and nuts to maintain the unit cells at the same interval and pressure, the nuts may be pushed back due to vibration generated during driving.

This may cause damage or the like to the fuel cell stack. In this case, various methods such as use of double nuts, washer insertion, and coupling using bonds have been applied in order to prevent the loosening of the nuts fastened to the full threaded bolts as described above. However, these methods also do not prevent completely the loosening of the nuts.

Conventionally, Korean Patent No. 10-179060 (Sep. 11, 2017) discloses a bolt assembly having an anti-loosening nut, but there is a problem in that the nut is loosened when excessive vibration occurs. In addition, Korean Patent No. 10-1103171 (Dec. 29, 2011) discloses an insert anti-loosening nut, but there is a problem in that the nut is loosened when nylon rings or synthetic resin molded articles deteriorate over time.

### Patent Document

Korean Patent No. 10-179060 (Sep. 11, 2017)

Korean Patent No. 10-1103171 (Dec. 29, 2011)

### SUMMARY

Various embodiments are directed to an anti-loosening fastener for fuel cell stacks, which is capable of having a simple structure to ensure productivity or reliability of operation and prevent a fastening force of the fastener from decreasing due to vibration generated during driving, thereby maintaining performance of a fuel cell stack and prolonging a life of a fuel cell.

In accordance with an aspect of the present disclosure, there is provided an anti-loosening fastener for fuel cell stacks, including:
a full threaded bolt (100) exposed through a fuel cell stack and provided with a threadless part (110) having a predetermined length;
a positioner (200) screwed to a male threaded part (120) of the full threaded bolt (100) and having a coupling hole (241) coupled to a stopper (300); and
the stopper (300) slidably fitted to the threadless part (110) of the full threaded bolt (100) while having a stopper protrusion (330) coupled to the coupling hole (241). Accordingly, it is possible to prevent a fastening force of the fastener from decreasing due to vibration generated during driving, to maintain the performance of the fuel cell stack and prolong the life of the fuel cell, and to ensure reliability of operation.

### BRIEF DESCRIPTION OF THE DRAWINGS

FIG. 1 is a perspective view illustrating an anti-loosening fastener for fuel cell stacks according to an embodiment of the present disclosure.

FIG. 2 is an exploded perspective view illustrating the anti-loosening fastener for fuel cell stacks according to the embodiment of the present disclosure.

FIG. 3 is an exploded bottom perspective view illustrating the anti-loosening fastener for fuel cell stacks according to the embodiment of the present disclosure.

FIG. 4 is a longitudinal cross-sectional view illustrating the anti-loosening fastener for fuel cell stacks according to the embodiment of the present disclosure.

FIG. 5 is an exploded perspective view illustrating an anti-loosening fastener for fuel cell stacks according to another embodiment of the present disclosure.

FIG. 6 is an exploded bottom perspective view illustrating the anti-loosening fastener for fuel cell stacks according to another embodiment of the present disclosure.

FIG. 7 is a longitudinal cross-sectional view illustrating the anti-loosening fastener for fuel cell stacks according to another embodiment of the present disclosure.

### DETAILED DESCRIPTION

Hereinafter, specific embodiments will be described with reference to the accompanying drawings since the present disclosure may be subjected to various modifications and have various examples. It should be understood, however, that the present disclosure is not intended to be limited to the specific embodiments, but the present disclosure includes all modifications, equivalents or replacements that fall within the spirit and scope of the disclosure as defined in the following claims.

These embodiments are provided to explain the present disclosure in more detail to those skilled in the art to which the present disclosure pertains. The drawings are not necessarily to scale and in some instances, proportions may have been exaggerated in order to clearly illustrate features of the embodiments. In certain embodiments, a detailed description of configurations well known in the art may be omitted to avoid obscuring appreciation of the disclosure by those skilled in the art.

Terms such as “first” and/or “second” may be used herein to describe various elements of the present disclosure, but these elements should not be construed as being limited by the terms. These terms will be used only for the purpose of differentiating one element from other elements of the present disclosure.

The terminology used herein is for the purpose of describing particular embodiments only, and is not intended to limit the present disclosure. As used herein, the singular forms “a”, “an” and “the” are intended to include the plural forms as well, unless the context clearly indicates otherwise.

In the disclosure, terms such as “comprises/includes” and/or “have/has” should be construed as designating that there are such features, integers, steps, operations, components, parts, and/or combinations thereof, not to exclude the presence or possibility of adding of one or more of other features, integers, steps, operations, components, parts, and/or combinations thereof.

First, the present disclosure may include one of a full threaded bolt 100, a positioner 200, and a stopper 300.

Hereinafter, exemplary embodiments of the present disclosure will be described in more detail with reference to the accompanying drawings.

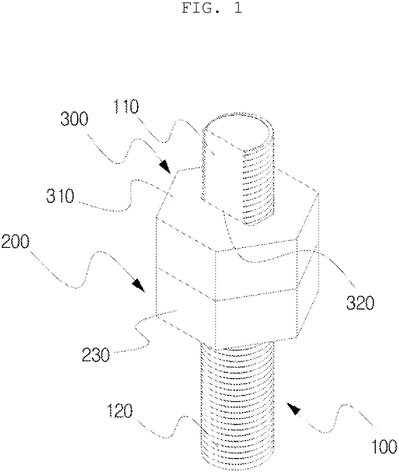

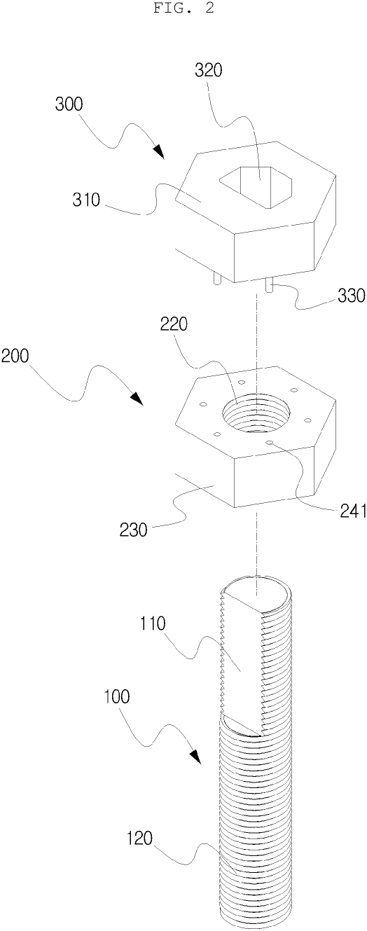

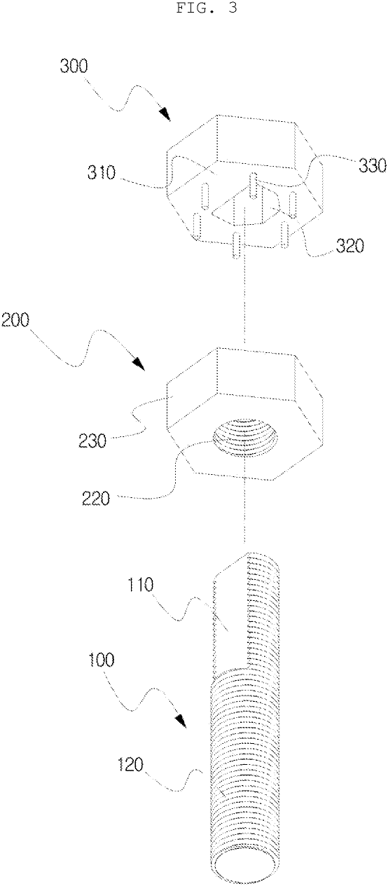

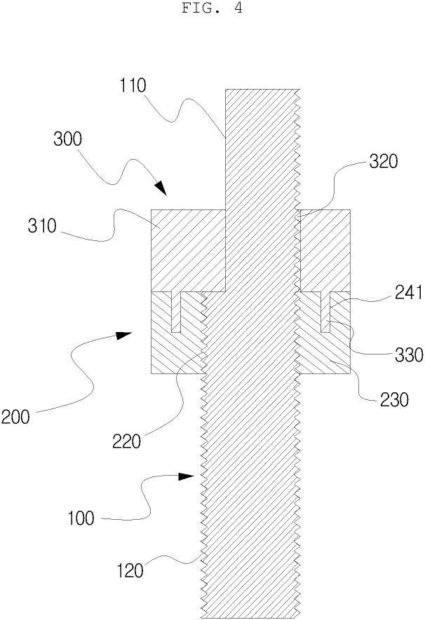

FIG. 1 is a perspective view illustrating an anti-loosening fastener for fuel cell stacks according to an embodiment of the present disclosure. FIG. 2 is an exploded perspective view illustrating the anti-loosening fastener for fuel cell stacks according to the embodiment of the present disclosure. FIG. 3 is an exploded bottom perspective view illustrating the anti-loosening fastener for fuel cell stacks according to the embodiment of the present disclosure. FIG. 4 is a longitudinal cross-sectional view illustrating the anti-loosening fastener for fuel cell stacks according to the embodiment of the present disclosure.

Referring to FIGS. 1 to 4, the anti-loosening fastener for fuel cell stacks according to the embodiment of the present disclosure includes a full threaded bolt 100 exposed through a fuel cell stack and provided with a threadless part 110 having a predetermined length, a positioner 200 screwed to a male threaded part 120 of the full threaded bolt 100 and having a coupling hole 241 coupled to a stopper protrusion 330, and a stopper 300 slidably fitted to the threadless part 110 of the full threaded bolt 100 while having the stopper protrusion 330 coupled to the coupling hole 241.

The full threaded bolt 100 is provided with a male thread having a predetermined pitch and formed over the entire length thereof on the outer periphery thereof having a predetermined diameter. The threadless part 110 is formed to have a D-shape by planing the outer periphery of the full threaded bolt 100 by a predetermined length, so that the threadless part 110 is slidably fitted into a guide hole 320 of a stopper body 310, which will be described later, thereby preventing the stopper 300 from rotating.

The positioner 200 is screwed to the male threaded part 120 of the full threaded bolt 100 to laterally apply a pressing or tightening force thereto. The positioner 200 includes a female threaded part 220 formed on the inner periphery thereof and screwed to the male threaded part 120 of the full threaded bolt 100, and a positioner body 230 having a polygonal tool latching part formed on the outer periphery thereof.

The stopper protrusion 330 is coupled to the coupling hole 241 formed in the positioner body 230, thereby completely preventing the positioner 200 from loosening or being decoupled from the full threaded bolt 100 due to vibration. The coupling hole 241 has a predetermined diameter and depth and may consist of one or more coupling holes provided at equal intervals between the female threaded part 220 and the positioner body 230. Such multiple coupling holes 241 enables the positioner 200 to remain fixed at an optimal position by increasing or decreasing a tightening force.

The stopper 300 serves to fundamentally prevent the positioner 200 screwed to the full threaded bolt 100 from rotating. The guide hole 320 is formed in the stopper body 310 having the same shape as the positioner body 230 in external appearance, and has a D-shape so that it is slidably fitted to the threadless part 110 of the full threaded bolt 100.

To this end, each of the coupling holes 241 is formed in the positioner body 230, and the stopper protrusion 330 is fitted into the coupling hole 241. Here, the stopper protrusion 330 may have a cylindrical shape for easy manufacture and assembly.

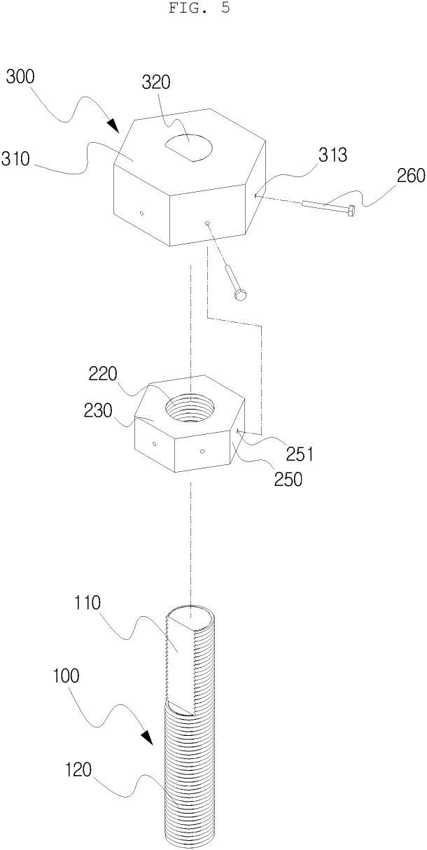

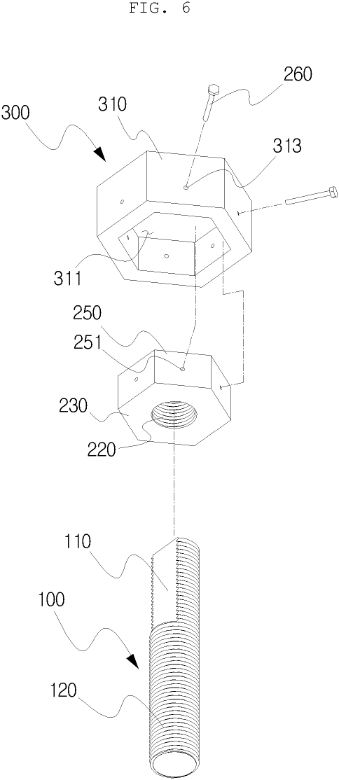

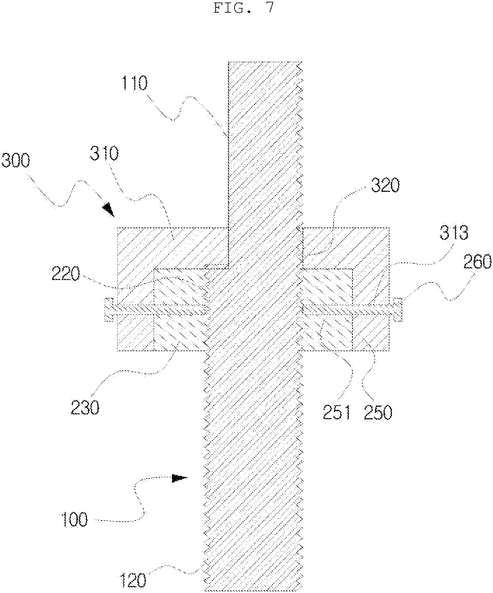

FIG. 5 is an exploded perspective view illustrating an anti-loosening fastener for fuel cell stacks according to another embodiment of the present disclosure. FIG. 6 is an exploded bottom perspective view illustrating the anti-loosening fastener for fuel cell stacks according to another embodiment of the present disclosure. FIG. 7 is a longitudinal cross-sectional view illustrating the anti-loosening fastener for fuel cell stacks according to another embodiment of the present disclosure.

In the anti-loosening fastener for fuel cell stacks according to the previous embodiment, the male threaded part 120 of the full threaded bolt 100 is screwed to the female threaded part 220 of the positioner 200, and the stopper 300 is slidably fitted to the threadless part 110 provided in the full threaded bolt 100 while the stopper protrusion 330 provided on the stopper body 310 is fitted into the coupling hole 241 in order to prevent loosening of them. In addition to such a configuration, as illustrated in FIGS. 5 to 7, the anti-loosening fastener for fuel cell stacks according to the present embodiment includes a full threaded bolt 100, a positioner 200, and a stopper 300. The positioner 200 includes a female threaded part 220 formed on the inner periphery thereof and screwed to a male threaded part 120 of the full threaded bolt 100, a positioner body 230 having a polygonal latching part 250 formed on the outer periphery thereof, and an inner female threaded part 251 through which a set screw 260 is screwed to the polygonal latching part 250.

The stopper 300 has a guide hole 320 having a D-shape and formed on the top of a stopper body 310 having a positioner insertion space 311 which is open at the bottom thereof. The stopper 300 has an outer female threaded part 313 through which each set screw 260 is screwed to the outer portion of the stopper body 310 when the positioner body 230 is coupled to the positioner insertion space 311 of the stopper 300 and the stopper 300 is slidably fitted to the threadless part 110, provided in the full threaded bolt 100, through the D-shaped guide hole 320 formed on the top of the stopper body 310. The set screw 260 screwed to the outer female threaded part 313 is pressed against the male threaded part 120 of the full threaded bolt 100 by passing through the inner female threaded part 251 of the positioner body 230.

As is apparent from the above description, the anti-loosening fastener according to the present disclosure can have a simple structure to ensure productivity or reliability of operation.

In addition, this enables the fastening force of the fastener to be prevented from decreasing due to vibration generated during driving.

Moreover, it is possible to maintain the performance of the fuel cell stack and prolong the life of the fuel cell.

While the present disclosure has been described with respect to the embodiments illustrated in the drawings, it will be obvious to those skilled in the art that such embodiments are provided by way of example only. Therefore, it will be understood by those skilled in the art that various substitutions, modifications, and variations may be made without departing from the spirit and scope of the disclosure as defined in the following claims.

What is claimed is:

1. An anti-loosening fastener for fuel cell stacks, comprising:
a full threaded bolt exposed through a fuel cell stack and provided with a threadless part having a predetermined length;
a positioner screwed to a male threaded part of the full threaded bolt and having a coupling hole coupled to a stopper protrusion; and
a stopper slidably fitted to the threadless part of the full threaded bolt while having the stopper protrusion coupled to the coupling hole.

2. The anti-loosening fastener according to claim 1, wherein the threadless part is formed to have a D-shape by planing an outer periphery of the full threaded bolt by a predetermined length.

3. The anti-loosening fastener according to claim 1, wherein:
the positioner comprises a female threaded part formed on an inner periphery thereof and screwed to the male threaded part of the full threaded bolt, and a positioner body having a polygonal tool latching part formed on an outer periphery thereof; and
the coupling hole has a predetermined diameter and depth and consists of one or more coupling holes provided at equal intervals between the female threaded part and the positioner body.

4. The anti-loosening fastener according to claim 1, wherein the stopper comprises:
a stopper body having the same shape as a positioner body in external appearance;
a guide hole formed in the stopper body and having a D-shape so that the guide hole is slidably fitted to the threadless part of the full threaded bolt; and
the stopper protrusion fixedly fitted into the coupling hole of the positioner body.

5. The anti-loosening fastener according to claim 4, wherein the stopper protrusion has a cylindrical shape.

6. The anti-loosening fastener according to claim 1, wherein:
the positioner comprises a female threaded part formed on an inner periphery thereof and screwed to the male threaded part of the full threaded bolt, and a positioner body having a polygonal latching part formed on an outer periphery thereof; and
the positioner comprises an inner female threaded part through which a set screw is screwed to the polygonal latching part.

7. The anti-loosening fastener according to claim 1, wherein the stopper comprises a guide hole having a D-shape and formed on the top of a stopper body having a positioner insertion space which is open at the bottom thereof, and an outer female threaded part through which each set screw is screwed to an outer portion of the stopper body, and the set screw screwed to the outer female threaded part is pressed against the male threaded part of the full threaded bolt by passing through an inner female threaded part of a positioner body.
